(19) United States
(12) Patent Application Publication
(10) Pub. No.: US 2004/0106712 A1
(43) Pub. Date: Jun. 3, 2004

(54) Coating composition for reinforcing wood or wood joint and wood structure reinforced by same

(75) Inventor: Kunishige Miyoshi, Sakado-shi (JP)

Correspondence Address: OLIFF & BERRIDGE, PLC, P.O. BOX 19928, ALEXANDRIA, VA, 22320, US

(73) Assignee: FIBER KAKEN CO., LTD., Sakado-shi (JP)

(21) Appl. No.: 10/657,148

(22) Filed: Sep. 9, 2003

(30) Foreign Application Priority Data
Mar. 5, 2002 (JP) 2002-59396

(51) Int. Cl. C08K 3/38; C08K 3/10; C08K 5/00

(52) U.S. Cl. 524/404; 523/457; 524/437

(57) ABSTRACT

There is provided a paste coating composition for reinforcing wood or wood joint comprising: (A) an epoxy resin containing a curing agent, (B) a first fiber composed of a ceramic fiber, and (C) a second fiber composed of an aramid fiber or a polyketone fiber, wherein contents of components (B) and (C) are 1.5 to 5% by weight and 1 to 7% by weight based on a weight of component (A), respectively; and a wood structure reinforced by the composition. The composition can be easily applied for wood structures thereby imparting a remarkable improvement in strength to the structures.

### TECHNICAL FIELD

The present invention relates to a paste coating composition for [symbol] forcing wood or wood joint and a wood structure reinforced by the same.

### BACKGROUND ART

Conventionally, it has been known well to coat woods with a coating [symbol] composition in order to decorate the woods. However, ideas that application of such [symbol] ting composition for woods or wood joints can improve the strength of the woods [symbol] od joints have not been proposed.

In joining between a wood and another wood, a wood and a veneer [symbol] ood or a plywood and another plywood, conventional means, such as bolts and [symbol] screw nails or caulking tools have been employed. However, when a force is [symbol] ed on a member jointed with nails from the opposite direction from the direction in [symbol] the nails are put, the joining force in the member is not fully exerted. It Is [symbol] mes clear that this contributes to a great deal of damage resulting from the 1995 [symbol] t Hanshin-Awaji Earthquake

### DISCLOSURE OF INVENTION

An object of the present invention is to provide a novel paste [symbol] g composition for reinforcing wood or wood joint that changes a conception on [symbol] rior coating compositions for wood, and can be easily applied for wood structures [symbol] ding plywood, such as veneer plywood) thereby imparting a remarkable [symbol] vement in strength to the structures; and a wood structure reinforced by the [symbol] g composition.

That is, the present invention relates to a paste coating composition [symbol] inforcing wood or wood joint comprising: (A) an epoxy resin containing a curing [symbol] (B) a first fiber composed of a ceramic fiber; and (C) a second fiber composed [symbol] aramid fiber or a polyketone fiber, wherein contents of components (B) and (C) [symbol] 5 to 5% by weight and 1 to 7% by weight based on a weight of component (A), [symbol] ctively. In the meantime, the contents of components (B) and (C) are [symbol] ably 3.5 to 4.5% by weight and 4 to 6% by weight based on a weight of [symbol] onent (A), respectively. Further, the coating composition of the present invention may contain pigments or coatings as an optional component in a necessary amount, preferably 1 to 2% by weight based on a weight of component (A).

The present invention also relates to the paste coating composition for reinforcing wood or wood joint, wherein the composition has a viscosity of 10,000 cps to 35,000 cps, preferably 15,000 cps to 30,000 cps and more preferably 20,000 cps to 25,000 cps.

In addition, the present invention relates to a wood structure, in which any one of the above-mentioned paste coating compositions for reinforcing wood or wood joint is applied to a surface of the wood structure in a coat thickness (dried coat thickness) of 0.1 to 3 mm.

The first or second fiber used in the present invention has a length of 0.5 to 10 mm, preferably 1 to 6 mm, more preferably 1 to 4 mm. If the fibers have a length less than 0.5 mm, they cannot fully play a roll as reinforcing fibers, while if they have a length more than 10 mm, they deteriorate application properties of the coating composition and therefore are not preferable. The optimum length of the fibers depends on the material of respective fibers. Ceramic fibers as a first fiber have a length of 1 to 10 mm, preferably 3 to 6 mm, and aramid fibers or polyketone fibers as a second fiber have a length of 1 to 6 mm, preferably 3 to 5 mm.

The optimum size (diameter) of the fibers also depends on the material of the respective fibers. Ceramic fibers as a first fiber have a diameter of 160 to 600 μm, preferably 200 to 300 μm, and aramid fibers or polyketone fibers as a second fiber have a diameter of 5 to 20 μm, preferably 7 to 15 μm.

Ceramic fibers used in the present invention include, for example alumina fibers, boron fibers, silicon carbide fibers and so on.

Aramid fibers used in the present invention include, for example high-elasticity type, ultra-high-elasticity type and so on, and can be used alone or in a mixture comprising two or more carbon fibers, depending on the purpose. In addition, polyketone fibers have a molecular structure in which carbon monoxide is incorporated into the molecular of ethylene, and they are fibers extremely close to aramid fibers in strength, elongation, elasticity modulus, heat shrinkage or specific gravity according to the data from Asahi Kasei Corporation.

Epoxy resins used in the present invention are preferably ones for epoxy coatings of cold-drying type. These epoxy coatings may contain a curing agent, such as amines or amine adducts, polyamides (e.g., triethylene tetramine/dimer acid modified polyamides or the like), isocyanates and so on. The epoxy resins can be used as a solvent-free type by using liquid epoxy resins. They include, for example epoxy resins of bisphenol A-type, bisphenol E-type, bisphenol F-type or the like.

The curing agent for epoxy resin is not specifically limited. In case where the curing agent is previously formulated into the coating compositions of the present invention, it is preferable to use ketimine (ketoimine) curing agents. The ketimine curing agents can be produced by a reaction of amines, for example fatty polyamines such as diethylene triamine (DETA), triethylene tetramine (TETA), polymethylene diamine (PDA) or methaxylylene diamine (MXDA) with ketones such as methyl ethyl ketone (MEK) or isobutyl methyl ketone (MIBK), as shown in the following scheme:

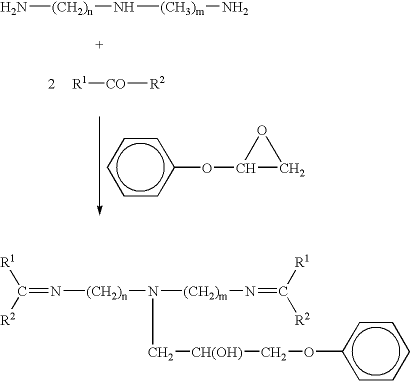

When ketimines produced by using a diamine as an amine are formulated into a resin, they exhibit extremely high stability. On the other hand, ketimines produced by using a polyamine have shorter pot-life than ones produced by using a diamine. The combination of amines with ketones in the ketimine curing agents includes for example MEK-DETA, MIBK-DETA, MIBK-EDA, MIBK-MXDA or DIBK(diisobutyl ketone)-MXPA, the pot-life of which increases in that order (the latter combination has a longer pot-life). When reduction in curing time is desired, water (0.5 to 2.0% by weight based on ketimine) or aliphatic polyamines (0.5 to 3.0% by weight based on ketimine) may be added as an accelerator.

Further, the paste coating compositions for reinforcing wood or wood joint according to the present invention may contain several additives that are usually added to coatings for woods. The additives include, for example dispersants, emulsifying agents, wetting agents, penetrants, anti-foam agents, suspension agents, thickening agents, anti-sag agents, anti-segregation agents, anti-skinning agents, UV absorbers, antistatic agents, mild wproofing agents, fireproofing agents or flame retardants, described at pages 433-444 of “Coating Material Handbook” edited by The Nikkan Kogyo Shinbun, Ltd.

When the composition of the present invention is used for reinforcing woods, it can be applied on a square timber or a board. On the other hand, when the composition is used for reinforcing wood joints, it can be applied on a part where one wood is inserted into the other wood, or it can be applied into gap between both woods. In case where a wood and another wood are joined with bolts and nuts, screw nails or caulking tools, or where a metal plate is laid on two woods and fixed with screw nails, the composition of the present invention can be coated on a suitable part immediately before the tools or metal plates are applied. In addition, the composition of the present invention can be applied into gap of joint face between woods, or be further coated on the tools or the like that are applied on the wood.

### EXAMPLES

In the followings, the present invention is described based on examples to which the present invention is not limited.

### Example 1

The following components: 1000 parts by weight of an epoxy resin (bisphenol F liquid epoxy resin), 38 parts by weight of ketimine curing agent for epoxy resin that is a reaction product of a ketone with an amine, 5 parts by weight of a ceramic fiber (length of the fiber: 2 mm), 5 parts by weight of an aramid fiber (length of the fiber: 4 mm), 0.1 part by weight of a pigment and 1 part by weight of an aerosil (a thickening agent) were mixed to obtain a coating composition. The coating composition was applied on 9 cm-square timber with thickness of 5 mm, dried and then cured for a week. Then, the square timber was tested on flexural strength, and the results thereof are shown in Table 1. In the meantime, this test was carried at Japan Testing Center for Construction Materials.

TABLE 1

| | No | | 2 Faces- | |
|---|---|---|---|---|
| | Application | 1 Face-Coating | Coating | 3 Faces-Coating |
| Load (KN) | 28.2 | 31.7 | 32.0 | 36.7 |
| Improvement | 100 | 112.4 | 113.5 | 130.1 |
| Rate of | | | | |
| Strength % | | | | |

(Note)
1 Face-Coating: The coating composition was applied on full face of one face of the square timber, and load was applied from an opposite face from the coating-applied face.
2 Faces-Coating: The coating composition was applied on full faces of two and continuous faces of the square timber, and load was applied from a face on which the coating was not applied.
3 Faces-Coating: The coating composition was applied on full faces of three faces of the square timber, and load was applied from a face on which the coating was not applied.

It is clear from the results in Table 1 that the square timber on three faces of which the coating composition according to the present invention was applied is improved in strength by about 30%.

### Example 2

The composition of Example 1 was used in this example. The shape and size of a metal plate, and the shape, size and applied position of bolts for fixing the metal plate are as follows:

Metal plate: L-shaped, thickness: 5 mm, width: 50 mm, length of face to be applied: 200 mm; and

Bolt: Coach Bolt CYI, diameter 9 mm, applied position: 45 mm and 145 mm from tip end of the metal plate.

The metal plate was laid on a predetermined position of a joined portion of two 9 cm-square timbers, the coating composition according to the present invention was applied thereon, and immediately the metal plate was fixed on the square timber with the bolts. After curing for 3 days, the square timbers were tested on tensile strength, and the results thereof are shown in Table 2. In the meantime, this test was carried at Japan Testing Center for Construction Materials.

### Example 3

The procedure of Example 2 was repeated except that the coating composition according to the present invention was previously applied with thickness of 3 mm on a part of the square timbers where the metal plate was applied, and the composition was applied further on the metal plate with thickness of 3 mm. The results are shown in Table 2.

TABLE 2

| | No Application | Example 2 | Example 3 |
|---|---|---|---|
| Load (KN) | 2.9 | 5.3 | 8.0 |
| Improvement | 100 | 182.8 | 275.9 |
| Rate of | | | |
| Strength (%) | | | |

It is clear from the results in Table 2 that the joined portions of woods are surprisingly increased in strength.

The present invention provides a novel paste coating composition for reinforcing wood or wood joint. Further, wood structures of the present invention is remarkably improved in its strength as shown in Examples 1 to 3.

What is claimed is:

1. A paste coating composition for reinforcing wood or wood joint comprising:
(A) an epoxy resin containing a curing agent;
(B) a first fiber composed of a ceramic fiber; and
(C) a second fiber composed of an aramid fiber or a polyketone fiber,
wherein contents of components (B) and (C) are 1.5 to 5% by weight and 1 to 7% by weight based on a weight of component (A), respectively.

2. A paste coating composition for reinforcing wood or wood joint according to claim 1, wherein the composition has a viscosity of 10,000 cps to 35,000 cps.

3. A wood structure, in which the paste coating composition for reinforcing wood or wood joint according to claim 1 is applied to a surface of the wood structure in a coat thickness (dried coat thickness) of 0.1 to 3 mm.

4. A wood structure, in which the paste coating composition for reinforcing wood or wood joint according to claim 2 is applied to a surface of the wood structure in a coat thickness (dried coat thickness) of 0.1 to 3 mm.
